(19) United States
(12) Patent Application Publication
(10) Pub. No.: US 2026/0209024 A1
(43) Pub. Date: Jul. 23, 2026

(54) BEVERAGE DISCHARGE DEVICE

(71) Applicant: COWAY CO., LTD., Gongju-si (KR)

(72) Inventors: Jung Hwan OH, Gongju-si (KR); Il CHU, Gongju-si (KR)

(73) Assignee: COWAY CO., LTD., Gongju-si (KR)

(21) Appl. No.: 19/139,024

(22) PCT Filed: Nov. 30, 2023
(86) PCT No.: PCT/KR2023/019582

§ 371 Date: Jun. 13, 2025

(30) Foreign Application Priority Data
Dec. 22, 2022 (KR) 10-2022-0181430

(51) Int. Cl. B67D 1/07

(52) U.S. Cl. CPC B67D 1/07; B67D 2001/075; B67D 2210/00015

(57) ABSTRACT

The present invention relates to a beverage discharge device. More specifically, disclosed is a beverage discharge device capable of selectively sterilizing an inner flow path of a faucet and extracted water. The beverage discharge device according to one aspect of the present invention includes a faucet, a sterilization module and a driving module, wherein the location of the sterilization module is moved to a first location and a second location.

### TECHNICAL FIELD

The present invention relates to a beverage discharge device, and more particularly, to a beverage discharge device capable of selectively sterilizing an inner flow path of a faucet and extracted water.

### BACKGROUND

The beverage discharge device is connected to a beverage supply source and discharges beverage from the beverage supply source to the outside and supplies it to the user.

These beverage discharge devices are installed in beverage supply sources such as water purifiers that filter and supply water, carbonated water makers that inject carbon dioxide gas into water and juice to make carbonated water, and coffee machines.

In addition, the beverage discharge device equipped in the beverage supply source enables the beverage to be discharged to the outside as an extracted water through a faucet having an inner flow path according to control.

Meanwhile, in the midst of the COVID-19 pandemic, interest in personal hygiene as well as disinfection and sterilization of various items that users come into contact with is increasing.

In particular, cleanliness management is essential for areas that people come into contact with, as there are many cases where various bacteria or foreign substances are present on or near the contact area, and there is a risk that they can spread to many people in a short period of time.

Meanwhile, when the beverage discharge device described above is used in each home, institution, or office, germs on the hands and germs or dust floating in the air will come into contact with the extraction port of the faucet. In addition, during the extraction process to fill the container for receiving the beverage, the faucet and the container come into contact, so a large number of bacteria will inevitably always come into contact and exist on the faucet.

Accordingly, various technologies are being developed to sterilize these faucets, and one method is being disclosed in which sterilization is performed by irradiating them with sterilizing light (UV light) such as ultraviolet rays.

As a related art for this purpose, Korean Patent Registration No. 10-0628705 discloses an “LED sterilization water cock.”

This related art, as seen through FIG. 2 of the published literature, shows a technology for sterilizing and drying a water cock 50 by attaching an ultraviolet LED (light emitting diode) lamp (hereinafter referred to as a ‘UV irradiation unit’) to the inside of a water cock 50 faucet-of a water purifier 20, a water dispenser 10, or a water ionizer 30.

However, although this related art showed a sterilization concept for a faucet-water cock 50, there was a problem that it was not easy to efficiently place the UV irradiation unit on the narrow inner flow path of the faucet.

Meanwhile, the UV irradiation unit has a lifespan and must be replaced with a new one when its lifespan ends.

However, in Korean Patent Registration No. 10-0628705, the UV irradiation unit is installed on the inner flow path of the faucet, so there was a problem that the entire faucet including the UV irradiation unit had to be removed and replaced in order to replace the UV irradiation unit.

In addition, since the UV irradiation unit was placed in a location where it would directly come into contact with water, there was a problem that it was difficult to replace the UV irradiation unit.

### DISCLOSURE

### Technical Problem

The present invention aims to solve the above problems, and the present invention is directed to providing a beverage discharge device capable of selectively sterilizing an inner flow path of a faucet and extracted water discharged through an extraction port.

The present invention is also directed to providing a beverage discharge device capable of blocking the extraction port of the faucet when extracted water is not being discharged, thereby preventing contamination of the inner flow path of the faucet.

The problems of the present invention are not limited to those mentioned above, and other problems not mentioned will be clearly understood by those of ordinary skill in the art from the following description.

### Technical Solution

According to an aspect of the present invention, a beverage discharge device is provided.

In this case, the beverage discharge device includes a faucet that includes an inner flow path through which processed extracted water flows and an extraction port formed at the end of the inner flow path to allow the extracted water to be discharged to the outside; a sterilization module having a UV irradiation unit on one side and rotatably coupled to the extraction port to be rotatable relative to the extraction port ; and a driving module configured to position the sterilization module at a first position where the UV irradiation unit faces the inner flow path or at a second position where the UV irradiation unit does not face the inner flow path but instead faces the extracted water being discharged through the extraction port.

In this case, the beverage discharge device further includes an input unit configured to receive a command for discharging the extracted water.

In addition, the driving module positions the sterilization module at the second position in response to the command for discharging input from the input unit.

Meanwhile, the driving module positions the sterilization module at the first position upon completion of the extracted water discharge.

In addition, the sterilization module continuously operates the UV irradiation unit while positioned at the second position.

Meanwhile, the sterilization module may operate the UV irradiation unit only for a specific time interval while positioned at the first position.

In addition, when returning from the second position to the first position, the sterilization module selectively operates the UV irradiation unit for a set time.

In an embodiment, the sterilization module, which constitutes the beverage discharge device of the present invention, may have a size and shape capable of blocking the extraction port of the faucet, which is oriented toward the ground, and one or more UV irradiation units may be disposed on one side of the stopper.

In this case, the stopper includes a hinge shaft formed on one side of an end of the faucet in which the extraction port is formed, and a blocking plate that rotates about the hinge shaft as a central axis to block the extraction port.

Meanwhile, if necessary, the blocking plate further includes a fixing member at an end opposite to the hinge shaft, the fixing member configured to be fixed to the other side of the end of the faucet.

In addition, the blocking plate has a shape corresponding to the end of the faucet where the extraction port is formed.

Meanwhile, the driving module includes a motor, and the hinge shaft is operatively connected to the drive shaft of the motor.

Meanwhile, according to an embodiment, the extraction port of the faucet has a polygonal shape in which one side is longer than the other sides. In this case, the UV irradiation unit is disposed at the second position to face the extracted water discharged along the longer side.

For example, the extraction port may have a rectangular shape.

The sterilization module, which constitutes the beverage discharge device of the present invention, includes a first plate having a size and shape capable of blocking the extraction port and provided with the UV irradiation unit on one side, and a second plate extending from one side of the first plate with a predetermined length.

In this case, the first plate is configured to be slidable together with the second plate below the extraction port to block or open the extraction port and is configured to pivotally rotate relative to the second plate in the second position so that the UV irradiation unit is directed toward the extracted water.

Meanwhile, in an embodiment, the driving module includes a motor, and a gearbox provided under the second plate.

Meanwhile, a plurality of UV irradiation units may be arranged such that different numbers of UV irradiation units may operate at the first position and the second position.

In addition, the UV irradiation unit may further include a micro motor provided on one side of the sterilization module and be configured to be rotatable about an axis within a preset angular range by the micro motor.

### ADVANTAGEOUS EFFECT

According to the above configuration, the beverage discharge device of the present invention can selectively sterilize the inner flow path of the faucet and the extracted water as the sterilization module moves, under control, between a first position where the UV irradiation unit of the sterilization module faces the inner flow path of the faucet and a second position where the UV irradiation unit faces the extracted water discharged through the extraction port.

In addition, when extracted water is not being discharged, the sterilization module blocks the extraction port of the faucet, thereby preventing contamination of the inner flow path of the faucet in advance.

In addition, as the UV irradiation unit of the sterilization module is exposed to the outside at the second position, the replacement or repair of the UV irradiation unit is facilitated.

In addition, the sterilization module can operate different numbers of UV irradiation units at the first position and second position, thereby enhancing the sterilization effect while preventing the unnecessary operation of UV irradiation units, which extends their lifespan (replacement cycle).

Advantageous effects of the present invention are not limited to the above-described effects, and should be understood to include all effects that can be inferred from the configuration of the invention described in the detailed description or claims of the present invention.

### BRIEF DESCRIPTION OF THE DRAWINGS

FIG. 1 is a schematic diagram showing a first position of a beverage discharge device according to an exemplary embodiment of the present invention.

FIG. 2 is a schematic diagram showing a second position of a beverage discharge device according to an exemplary embodiment of the present invention.

FIG. 3 is a block diagram showing a beverage discharge device according to an exemplary embodiment of the present invention.

FIG. 4 is a schematic flowchart showing the operation of a beverage discharge device in a first position according to an exemplary embodiment of the present invention.

FIG. 5 is a schematic flowchart showing variable operation between the first position and the second position of a beverage discharge device according to an exemplary embodiment of the present invention.

FIG. 6 is a schematic diagram showing sterilization of an inner flow path of a beverage discharge device according to an exemplary embodiment of the present invention.

FIG. 7 is a schematic diagram showing sterilization of extracted water of a beverage discharge device according to an exemplary embodiment of the present invention.

FIG. 8 is a schematic diagram showing sterilization of an inner flow path of a beverage discharge device according to another exemplary embodiment of the present invention.

FIG. 9 is a schematic diagram showing sterilization of extracted water of a beverage discharge device according to another exemplary embodiment of the present invention.

FIG. 10 is a schematic diagram showing an example of a UV irradiation unit applied to a beverage discharge device according to an exemplary embodiment of the present invention.

### BEST MODES FOR CARRYING OUT THE INVENTION

In a preferred embodiment, the present invention provides a beverage discharge device, including: a faucet that includes an inner flow path through which processed extracted water flows and an extraction port formed at the end of the inner flow path to allow the extracted water to be discharged to the outside; a sterilization module having a UV irradiation unit on one side and rotatably coupled to the extraction port to be rotatable relative to the extraction port; and a driving module configured to position the sterilization module at a first position where the UV irradiation unit faces the inner flow path or at a second position where the UV irradiation unit does not face the inner flow path but instead faces the extracted water being discharged through the extraction port.

### MODES OF THE INVENTION

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

Terms and words used in the present specification and claims should not be construed as limited to their usual or dictionary definition. They should be interpreted as meaning and concepts consistent with the technical idea of the present invention, based on the principle that inventors may appropriately define the terms and concepts to describe their own invention in the best way.

Accordingly, the embodiments described in the present specification and the configurations shown in the drawings correspond to preferred embodiments of the present invention, and do not represent all the technical idea of the present invention, so the configurations may have various examples of equivalent and modification that can replace them at the time of filing the present invention.

It should be understood that the terms “comprise or include” or “have” or the like when used in this specification, are intended to describe the presence of stated features, numbers, steps, operations, elements, components and/or a combination thereof but not preclude the possibility of the presence or addition of one or more other features, numbers, steps, operations, elements, components, or a combination thereof.

The presence of an element in/on “front”, “rear”, “upper or above or top” or “lower or below or bottom” of another element includes not only being disposed in/on “front”, “rear”, “upper or above or top” or “lower or below or bottom” directly in contact with other elements, but also cases in which another element being disposed in the middle, unless otherwise specified. In addition, unless otherwise specified, that an element is “connected” to another element includes not only direct connection to each other but also indirect connection to each other.

Hereinafter, a beverage discharge device according to an exemplary embodiment of the present invention will be described with reference to the accompanying drawings.

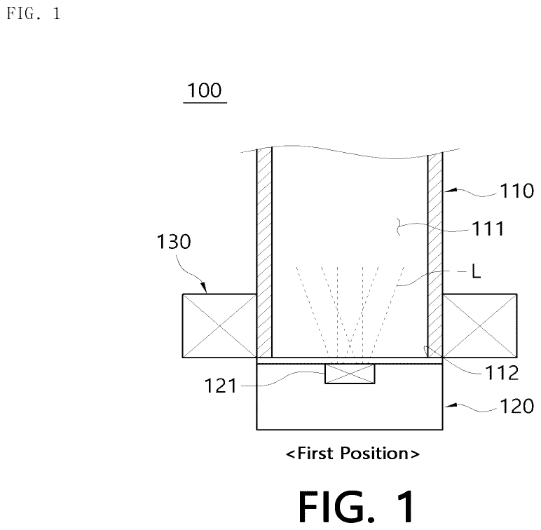

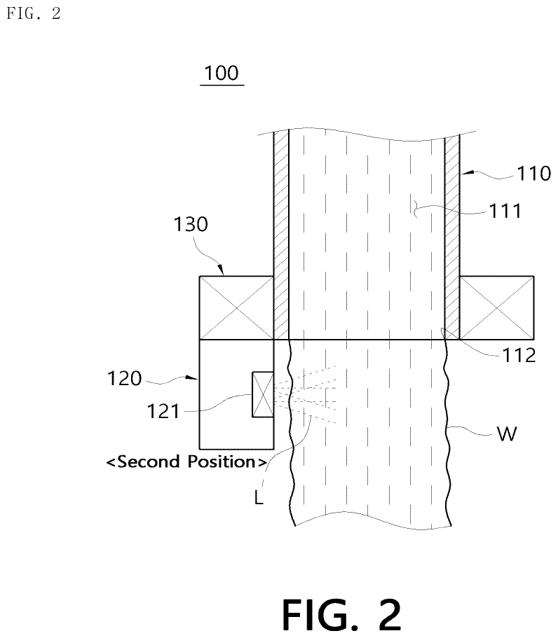

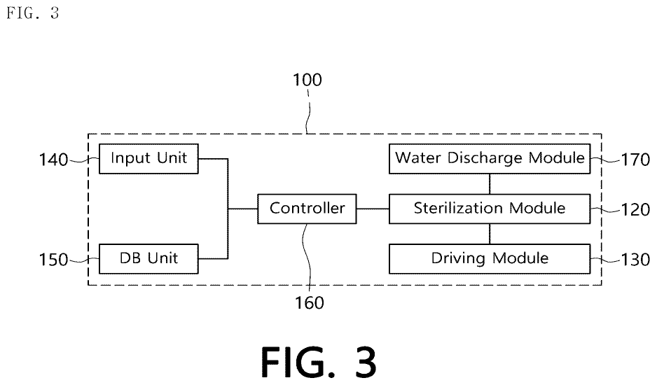

FIG. 1 is a schematic diagram showing a first position of a beverage discharge device according to an exemplary embodiment of the present invention, FIG. 2 is a schematic diagram showing a second position of a beverage discharge device according to an exemplary embodiment of the present invention, and FIG. 3 is a block diagram showing a beverage discharge device according to an exemplary embodiment of the present invention.

As shown in the drawings, the beverage discharge device 100 according to an exemplary embodiment of the present invention is configured to be movable between a first position, in which a UV irradiation unit 121 of a sterilization module 120 is directed toward an inner flow path 111 of a faucet 110 under control, and a second position, in which the UV irradiation unit 121 of the sterilization module 120 is directed toward the extracted water (W) discharged through an extraction port 112 instead of the inner flow path 111.

Accordingly, the beverage discharge device 100 according to an exemplary embodiment of the present invention can selectively sterilize the inner flow path 111 of the faucet 110 and the extracted water (W).

To this end, the beverage discharge device 100 according to an exemplary embodiment of the present invention primarily includes a water discharge module 170 including the faucet 110, a sterilization module 120, and a driving module 130.

In addition, the beverage discharge device 100 includes an input unit 140, a database (DB) unit 150, and a controller 160 to selectively control the operation of the water discharge module 170, the sterilization module 120, and the driving module 130.

First, the faucet 110 included in the beverage discharge device 100 according to an exemplary embodiment of the present invention is a component of the water discharge module 170 and has a tubular shape with an inner flow path 111 through which a beverage flows.

If necessary, the faucet 110 may be provided along with a water dispensing lever (not shown) and a valve (not shown) to discharge the beverage supplied from a beverage supply source (not shown) as extracted water (W) to the outside for a user to drink.

In the description of the present invention, the term “beverage” refers to all types of liquid substances discharged through the faucet 110, including water, liquid coffee, purified water, and drinks dispensed from vending machines.

Meanwhile, the water discharge module 170, including the faucet 110, has a known structure and configuration through various beverage discharge devices, and a detailed description thereof is omitted to avoid obscuring the gist of the present invention.

However, in the exemplary embodiment of the present invention, the faucet 110 has a tubular shape with an inner flow path 111, allowing the beverage supplied from a beverage supply source (not shown) to flow as extracted water (W).

And, of course, the faucet 110 may have various shapes as long as it forms an inner flow path 111 and an extraction port 112, such as a cylinder or a polygonal pillar.

Specifically, the faucet 110 applied to the beverage discharge device 100 according to an exemplary embodiment of the present invention includes an inner flow path 111 through which treated extracted water (W), processed for discharge such as by purification, flows, and an extraction port 112 formed at the end of the inner flow path 111 to allow the extracted water (W) to be discharged externally.

Meanwhile, the sterilization module 120 applied to the beverage discharge device 100 according to an exemplary embodiment of the present invention includes a UV irradiation unit 121 on one side, which emits UV light (L) to achieve a sterilization effect on a target object or target area.

Additionally, the sterilization module 120 is configured to be coupled to the extraction port 112 of the faucet 110 in a manner that allows relative rotation.

Accordingly, the sterilization module 120 may selectively open the extraction port 112 of the faucet 110 and can be moved between the first position and the second position by the driving module 130 under control.

Additionally, the sterilization module 120 operates the UV irradiation unit 121 at the selectively determined first position or second position to emit UV light (L).

The sterilization module 120 sterilizes the inner flow path 111 of the faucet 110 as a target area at the first position and sterilizes the extracted water (W), which is discharged through the extraction port 112, as a target object at the second position.

As is well known, UV (ultraviolet) refers to electromagnetic waves with a wavelength of approximately 10 to 400 nm and has the effect of inhibiting microbial reproduction by disrupting microbial metabolism through the destruction of DNA and RNA of microorganisms.

This sterilization effect of UV mainly occurs in the wavelength range of 200 nm to 280 nm. In particular, it is effective for all sterilization purposes, causes minimal changes to the irradiated object, and has the advantage of being simple to use.

Meanwhile, ultraviolet (UV) light can be classified into UV-A (wavelength range: 320-400 nm), UV-B (wavelength range: 280-320 nm), and UV-C (wavelength range: 200-280 nm) depending on its wavelength.

Among these, UV-C (wavelength range: 200-280 nm) has been applied for eliminating bacteria and viruses by inactivating unicellular organisms.

Additionally, while UV-A and UV-B also have sterilization effects, UV-C is known to exhibit an outstanding sterilization effect that is 1,000 to 10,000 times greater than that of UV-A or UV-B.

The UV emitted through the UV irradiation unit 121 applied to the sterilization module 120 of the present invention is not limited to a specific wavelength range; however, preferably, the UV-C wavelength range, which exhibits excellent sterilization effects, may be used.

Meanwhile, the sterilization module 120 may include a plurality of UV irradiation units 121 as needed.

Additionally, the sterilization module 120 may operate a different number of UV irradiation units 121 at the first position and the second position under control settings.

Accordingly, the sterilization effect on the target area or object of the sterilization module 120 can be enhanced, and unnecessary operation of the UV irradiation units 121 can be prevented, thereby extending the lifespan (replacement cycle) of the UV irradiation units 121.

Meanwhile, the beverage discharge device 100 according to an exemplary embodiment of the present invention includes a driving module 130 to move the sterilization module 120 to the first position or the second position.

Preferably, the driving module 130 is provided on one side of the faucet 110.

The driving module 130 positions the sterilization module 120 at the first position, where the UV irradiation unit 121 faces the inner flow path 111 of the faucet 110, under control settings.

In addition, the driving module 130 positions the sterilization module 120 at the second position, where the UV irradiation unit 121 does not face the inner flow path 111 but instead faces the extracted water (W) discharged through the extraction port 112, under control settings.

As long as the driving module 130 can move the position of the sterilization module 120, its structure is not limited to a specific design, and various known structures and configurations may, of course, be applied.

For example, the driving module 130 may have a structure that includes a motor and/or a gearbox. Alternatively, it may have a structure that includes a driving belt and a driving rail. Additionally, of course, it may further include a support structure (not shown) to support these components in the beverage discharge device 100.

Meanwhile, the beverage discharge device 100 according to an exemplary embodiment of the present invention includes an input unit 140, a database (DB) unit 150, and a controller 160 to selectively control the operation of the water discharge module 170, the sterilization module 120, and the driving module 130.

The input unit 140 is for receiving operation information to select various modes, such as turning the beverage discharge device 100 on/off and issuing extracted water discharge commands. The DB unit 150 stores operation (information) values for various modes of the device. The controller 160 generates control signals to execute the various modes by comparing the operation information received through the input unit 140 with the operation (information) values stored in the DB unit 150.

The input unit 140, database (DB) unit 150, and controller 160 are well-known components widely applied to devices operating based on electrical control signals. Their specific structures and functions are omitted to avoid obscuring the gist of the present invention.

However, the beverage discharge device 100 according to an exemplary embodiment of the present invention includes an input unit 140 that receives an extracted water (W) discharge command. In response to the discharge command input from the input unit 140, the driving module 130 moves the sterilization module 120 to the second position.

In this way, as the driving module 130 moves the sterilization module 120 to the second position, the extraction port 112 of the faucet 110 transitions to an open state, allowing the processed extracted water (W) to be discharged to the outside through the extraction port 112 under control.

Additionally, once the discharge of the extracted water (W) is complete, the driving module 130 moves the sterilization module 120 to the first position, causing the extraction port 112 to transition to a closed state.

Meanwhile, the sterilization module 120 continues to drive (operate) the UV irradiation unit 121 while it is located at the second position, allowing the extracted water (W) discharged through the extraction port 112 to be sterilized.

And, the sterilization module 120 drives (operates) the UV irradiation unit 121 while it is located at the first position, allowing the inner flow path 111 to be sterilized in response to a control signal.

At this time, the operation of the UV irradiation unit 121 may be performed only for a specific time interval according to the preset operation value.

The aforementioned specific time interval may refer to the time interval that has elapsed since the UV irradiation unit 121 was first positioned at the first position, a preset time interval such as 3 PM or 6 PM, or a time interval that has elapsed after a preset time has passed since the UV irradiation unit 121 previously operated to perform a sterilization process.

As such, the specific time interval is not limited thereto and may be variously applied as a time interval input by a user or administrator of the beverage discharge device 100 through the input unit 140 or as a preset time interval.

In addition, while the sterilization module 120 is positioned at the first position, the driving of the UV irradiation unit 121 may also be performed in response to a sterilization mode command—a driving command for the UV irradiation unit 121—input through the input unit 140, so that sterilization of the inner flow path 111 can be carried out.

Furthermore, when the sterilization module 120 returns from the second position to the first position by the driving module 130, if there is no re-discharge command for the extracted water (W), the UV irradiation unit 121 may be driven for a preset time to perform a sterilization process on the inner flow path 111.

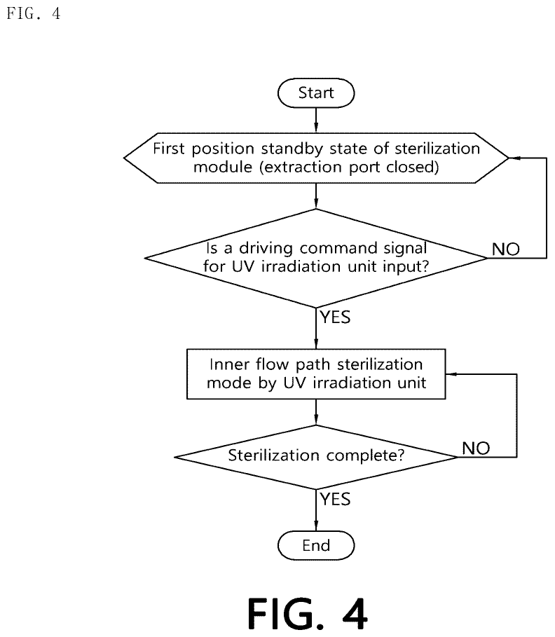

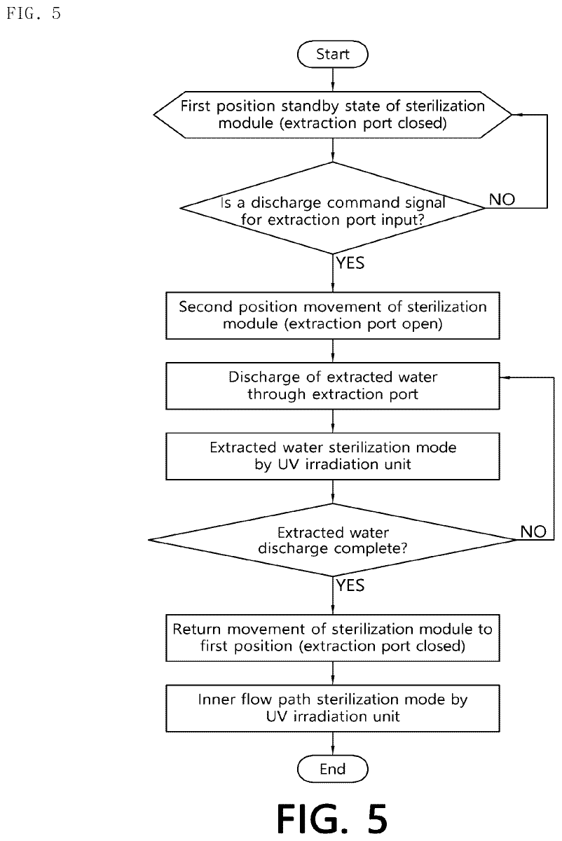

FIG. 4 is a schematic flowchart showing the operation of a beverage discharge device in a first position according to an exemplary embodiment of the present invention, and FIG. 5 is a schematic flowchart showing variable operation between the first position and the second position of a beverage discharge device according to an exemplary embodiment of the present invention.

Referring to FIGS. 4 and 5, the operation of the sterilization module 120 at the first position and the second position in the beverage discharge device 100 according to an exemplary embodiment of the present invention is specifically described as follows.

First, referring to FIG. 4, the beverage discharge device 100 is in a non-operating state at the initial start position, with the sterilization module 120 in the first position, where it blocks (closes) the extraction port 112 (see FIG. 1).

In the first position state, the UV irradiation unit 121 of the sterilization module 120 is in a state where its irradiation direction is directed toward the inner flow path 111.

And while the sterilization module 120 remains in the first position state, a drive command signal for the UV irradiation unit 121 may be generated through the controller 160 for a preset specific time interval.

Thus, when the drive command signal for the UV irradiation unit 121 is generated, the UV irradiation unit 121 irradiates UV light toward the inner flow path 111 of the faucet 110 to perform sterilization.

As described above, the specific time interval may refer to the time interval that has elapsed since the UV irradiation unit 121 was first positioned at the first position, a preset time interval such as 3 PM or 6 PM, or a time interval that has elapsed after a preset time has passed since the UV irradiation unit 121 previously operated to perform a sterilization process.

And, at this time, the operating time of the UV irradiation unit 121 may, of course, be arbitrarily set according to the size of the inner flow path 111 of the faucet 110.

Meanwhile, after the UV irradiation unit 121 operates for the preset time and completes the sterilization process, the sterilization module 120 remains in the first position and waits for the next command signal.

Next, referring to FIG. 5, the beverage discharge device 100 is in a non-operating state at the initial start position, with the sterilization module 120 in the first position, where it blocks (closes) the extraction port 112 (see FIG. 1).

And, when an extracted water (W) discharge command to discharge to the extraction port 112 is entered through the input unit 140, the driving module 130 moves the sterilization module 120 to the second position under control.

As the sterilization module 120 moves to the second position, the extraction port 112, which was previously blocked, opens, and the extraction port 112 remains in an open state (see FIG. 2).

Subsequently, the extracted water (W) is discharged to the outside for a set time through the extraction port 112 in response to the extracted water (W) discharge command.

At this time, the UV irradiation unit 121 of the sterilization module 120 is directed toward the extracted water (W) being discharged through the extraction port 112.

Then, simultaneously with the discharge of the extracted water (W), the UV irradiation unit 121 of the sterilization module 120 is driven to irradiate UV light (L) onto the extracted water (W).

Subsequently, the discharge of the extracted water (W) is completed.

Then, if an extracted water (W) discharge command is not re-entered within a preset time (e.g., 3 seconds, 5 seconds), the driving module 130 moves the sterilization module 120 back to the first position under control.

As the sterilization module 120 returns to the first position, the previously opened extraction port 112 is blocked, returning to a closed state, and the UV irradiation unit 121 is directed toward the inner flow path 111 of the faucet 110 (see FIG. 1).

At this time, the UV irradiation unit 121 may be selectively driven under control.

In other words, when the sterilization module 120 is moved to the first position from the second position according to the preset control, the UV irradiation unit 121 may be selectively driven for a predetermined period of time (e.g., 3 seconds or 5 seconds) to irradiate UV light (L) toward the inner flow path 111 while the extraction port 112 remains open, thereby sterilizing and eliminating any bacteria or germs that may have entered the inner flow path 111.

Then, the sterilization module 120 of the beverage discharge device 100 remains in a standby state at the first position until a separate control signal is received.

As described above, the beverage discharge device 100 according to an exemplary embodiment of the present invention includes: a faucet 110 that comprises an inner flow path 111 through which processed extracted water (W) flows and an extraction port 112 formed at the end of the inner flow path 111 to allow the extracted water (W) to be discharged to the outside; a sterilization module 120 having a UV irradiation unit 121 on one side and rotatably coupled to the extraction port 112 to be rotatable relative to the extraction port; and a driving module 130 that positions the sterilization module 120 at a first position where the UV irradiation unit 121 faces the inner flow path 111 or at a second position where the UV irradiation unit 121 does not face the inner flow path 111 but instead faces the extracted water (W) being discharged through the extraction port 112.

And, under control, the driving module 130 variably moves the sterilization module 120 from the first position to the second position or from the second position to the first position, thereby selectively sterilizing the inner flow path 111 of the faucet 110 and the extracted water (W) discharged through the extraction port 112.

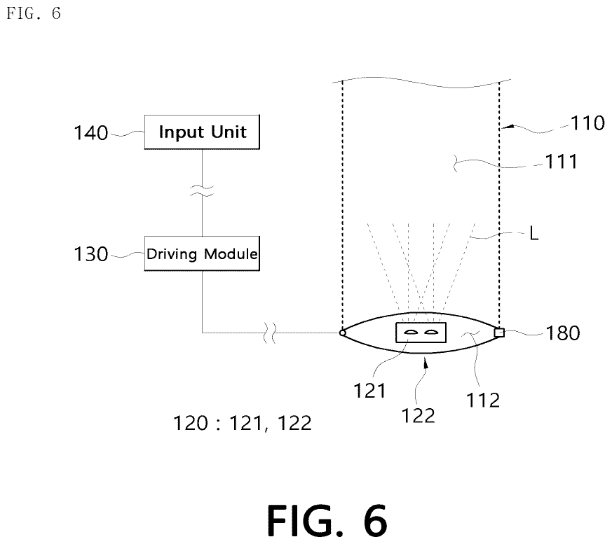

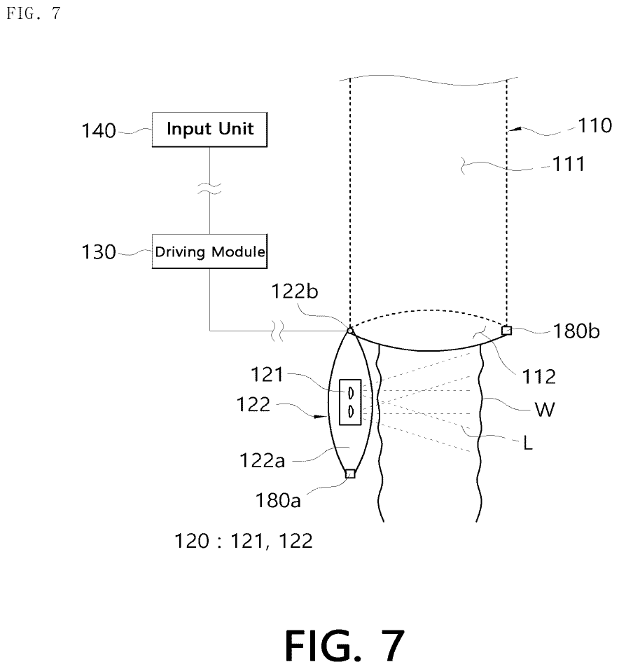

FIG. 6 is a schematic diagram showing sterilization of an inner flow path of a beverage discharge device according to an exemplary embodiment of the present invention, and FIG. 7 is a schematic diagram showing sterilization of extracted water of a beverage discharge device according to an exemplary embodiment of the present invention.

The beverage discharge device 100 according to an exemplary embodiment of the present invention is not limited to the configuration in which the sterilization module 120 selectively blocks the extraction port 112 of the faucet 110 and the driving module 130 moves the sterilization module 120 to the first position or the second position.

However, in an embodiment, referring to FIGS. 6 and 7, the sterilization module 120 applied to the beverage discharge device 100 according to an exemplary embodiment of the present invention may be a stopper 122 having a size and shape capable of blocking the extraction port 112 of the faucet 110, which is oriented to face the ground.

At this time, at least one UV irradiation unit 121 is disposed on one side of the stopper 122.

Meanwhile, the stopper 122 includes a hinge shaft 122b formed on one side of the end of the faucet 110 where the extraction port 112 is formed, and a blocking plate 122a that rotates about the hinge shaft 122b as a central axis to block the extraction port 112.

Accordingly, the stopper 122 is coupled to the extraction port 112 to be rotatable relative thereto via the hinge shaft 122b.

Meanwhile, the blocking plate 122a has a size and shape capable of completely covering the end of the faucet 110 where the extraction port 112 is formed.

To this end, the blocking plate 122a may have a flat, plate-like shape. Alternatively, if necessary, it may include a sidewall (not shown), where a part or the entirety of its edge extends from the first position toward the extraction port 112 to cover the outer end of the faucet 110 where the extraction port 112 is formed.

Meanwhile, the blocking plate 122a may have various sizes and shapes as long as it can completely cover the extraction port 112 in the first position to prevent external air from entering the inner flow path 111 of the faucet 110.

And, if necessary, the blocking plate 122a may have a shape corresponding to the end of the faucet 110 where the extraction port 112 is formed.

For example, if the end of the faucet 110 is circular, it has a correspondingly circular shape, and if the end of the faucet 110 is polygonal, it has a correspondingly polygonal shape.

Accordingly, the design aesthetics of the beverage discharge device 100 can be improved and the manufacturing cost can be reduced, and any possible safety accidents caused by the protruding blocking plate 122a can be prevented.

And, at least one UV irradiation unit 121 is provided on one side of the blocking plate 122a.

Meanwhile, the stopper 122, which includes the hinge shaft 122b and the blocking plate 122a, is moved to the first position or the second position by the driving module 130.

For example, the driving module 130 may include a motor, and the hinge shaft 122b may have a structure that is operatively connected to the drive shaft of the motor.

Meanwhile, referring again to FIGS. 6 and 7, the sterilization module 120 applied to the beverage discharge device 100 according to an exemplary embodiment of the present invention further includes a fixing member 180, which allows the blocking plate 122a constituting the stopper 122 to be fixed in position as needed.

That is, the blocking plate 122a further includes a fixing member 180 at an end opposite to the hinge shaft 122b, which may be fixed to the other end of the faucet 110.

For example, the fixing member 180 may be a hook or a magnet.

And the fixing member 180 may be in a form that is manually fixed or released by a user or operator of the beverage discharge device 100, or in a form that is automatically fixed or released according to a control signal.

The fixing member 180 is not limited thereto, and depending on the form, fixing members 180a and 180b may be provided at the ends of the blocking plate 122a and the faucet 110, respectively.

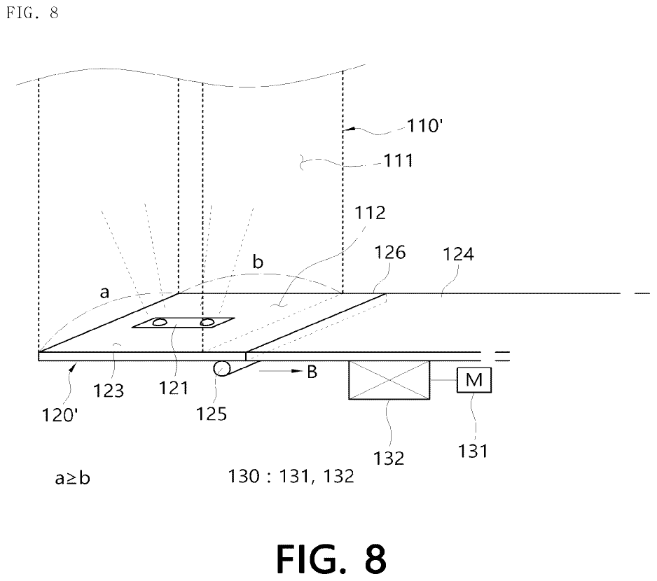

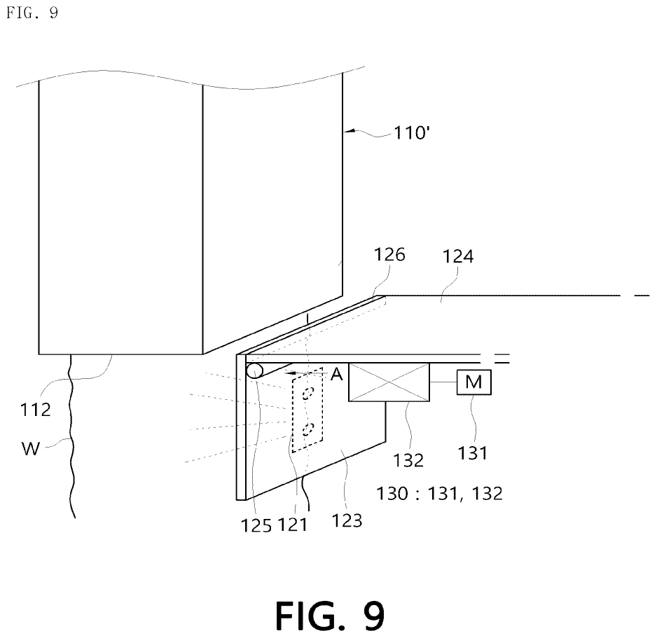

FIG. 8 is a schematic diagram showing sterilization of an inner flow path of a beverage discharge device according to another exemplary embodiment of the present invention, and FIG. 9 is a schematic diagram showing sterilization of extracted water of a beverage discharge device according to another exemplary embodiment of the present invention.

In another embodiment, referring to FIGS. 8 and 9, the sterilization module 120′ applied to the beverage discharge device 100 according to an exemplary embodiment of the present invention may have a size and shape capable of blocking the extraction port 112 of the faucet 110, which is oriented to face the ground, and have a plate shape that slides laterally to open and close the extraction port 112 by sliding motion.

In other words, the sterilization module 120′ includes a first plate 123 having a size and shape capable of blocking the extraction port 112 and provided with a UV irradiation unit 121 on one side, and a second plate 124 extending from one side of the first plate 123 with a predetermined length.

In this case, the first plate 123, which constitutes the sterilization module 120′, is configured to be slidable together with the second plate 124 below the extraction port 112 to block or open the extraction port 112, and is configured to pivotally rotate relative to the second plate 124 in the second position so that the UV irradiation unit 121 is directed toward the extracted water (W).

Through FIG. 8, it can be seen that the first plate 123 and the second plate 124, which constitute the sterilization module 120′, have slid in the ‘B’ direction, and the first plate 123 is in the first position, where it blocks the extraction port 112 of the faucet 110′.

Through FIG. 9, it can be seen that the first plate 123 and the second plate 124, which constitute the sterilization module 120′, have slid in the ‘A’ direction, and the first plate 123 has pivotally rotated relative to the second plate 124, reaching the second position where the extraction port 112 of the faucet 110′ is open.

Meanwhile, as described above, the faucet 110, 110′ applied to the beverage discharge device 100 according to an exemplary embodiment of the present invention may have various shapes as long as it forms an inner flow path 111 and an extraction port 112, such as a cylindrical or polygonal pillar shape.

As an example, in FIGS. 8 and 9, the faucet 110′ is illustrated in the form of a rectangular pillar.

In addition, the extraction port 112 of the faucet 110′ also has a rectangular shape.

Meanwhile, in the second position, the UV irradiation unit 121 of the sterilization module sterilizes the extracted water (W) as it is discharged through the extraction port 112.

At this time, to enhance the sterilization efficiency of the extracted water (W), it is necessary to maximize the area where the UV light (L) emitted from the UV irradiation unit 121 comes into contact with the extracted water (W).

Accordingly, when the faucet 110′ has a rectangular or polygonal pillar shape, and the extraction port 112 also has a rectangular or polygonal shape, it is preferable for the extraction port 112 to have a polygonal shape in which one side is longer than the other sides.

At this time, by positioning the UV irradiation unit 121 in the second position so that it faces the extracted water (W) flowing along the longer side, the sterilization efficiency of the extracted water (W) can be further enhanced.

In addition, a plurality of UV irradiation units 121 are arranged in the extraction direction of the extracted water (W), i.e., in the vertical direction, to further enhance the sterilization efficiency of the extracted water (W) (see FIG. 9).

Meanwhile, the UV irradiation unit 121 may be arranged in a horizontal or vertical direction as needed. Furthermore, as long as the UV light (L) emitted from the UV irradiation unit 121 can maximize the contact area with the extracted water (W), the UV irradiation unit 121 may be arranged in various orientations.

Of course, for aesthetic design considerations, the cross-sectional shape of the faucet 110, 110′ having the inner flow path 111 and the shape of the extraction port 112 formed at the end of the faucet may be different.

Meanwhile, as an example, in FIG. 8, the faucet 110′ has a rectangular pillar shape, and the extraction port 112 also has a rectangular shape.

In this case, the extraction port 112 has a rectangular shape in which the length of one side (a) is longer than the length of the other side (b).

And, as shown in FIG. 9, the UV irradiation unit 121 is arranged to face the extracted water (W) flowing along the longer side (a) and may irradiate UV light (L) over a wider surface according to control.

Meanwhile, referring again to FIGS. 8 and 9, the beverage discharge device 100 according to another exemplary embodiment of the present invention includes a driving module 130 to move the sterilization module 120′ between the first position and the second position.

In this case, the first plate 123 and the second plate 124, which constitute the sterilization module 120′, are arranged on top of a fixed rail pin 125, which functions as a roller and is supported on one side of the beverage discharge device 100, allowing them to slide in the ‘A’ or ‘B’direction.

Preferably, the fixed rail pin 125 is positioned between the end of the extraction port 112 and the pivot shaft 126, which connects the first plate 123 and the second plate 124, when the sterilization module 120′ is in the first position.

And, to enable the sliding movement of the first plate 123 and the second plate 124, the driving module 130 includes, for example, a motor 131, and a gearbox 132 provided under the second plate 124.

this case, the gearbox 132 may have a rack-and-pinion structure.

Accordingly, when the sterilization module 120′ slides in the ‘B’ direction as shown in FIG. 8, the first plate 123 rotates upward in the drawing (in a direction toward the extraction port) about the pivot shaft 126, thereby blocking (closing) the extraction port 112.

And, when the sterilization module 120′ slides in the ‘A’ direction as shown in FIG. 9, the first plate 123 rotates downward in the drawing (in a direction away from the extraction port) about the pivot shaft 126, thereby opening the extraction port 112.

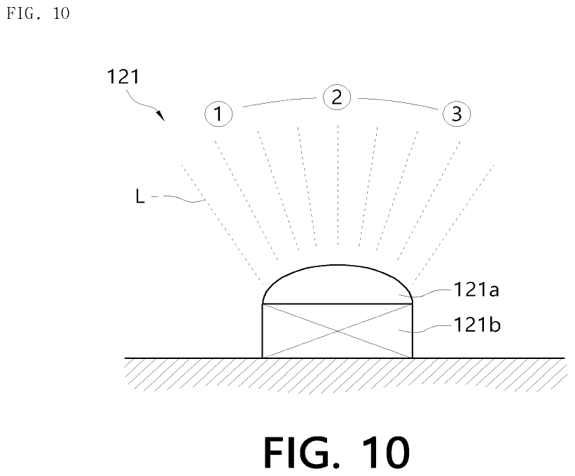

FIG. 10 is a schematic diagram showing an example of a UV irradiation unit applied to a beverage discharge device according to an exemplary embodiment of the present invention.

The sterilization module 120, 120′ applied to the beverage discharge device 100 according to an exemplary embodiment of the present invention includes at least one UV irradiation unit 121, as described above.

Meanwhile, as described above, to enhance the sterilization efficiency of the extracted water (W), it is necessary to maximize the area where the UV light (L) emitted from the UV irradiation unit 121 comes into contact with the extracted water (W) or the inner flow path 111.

To this end, the UV irradiation unit 121 included in the sterilization module applied to the beverage discharge device 100 according to an exemplary embodiment of the present invention is configured to vary the irradiation direction of the UV light (L) (\textcircled{1} [symbol] \textcircled{2} [symbol] \textcircled{3}) according to a predetermined control setting.

For example, the UV irradiation unit 121 may further include a micro motor 121b provided on one side of the sterilization module 120, 120′, and a UV lamp 121a that emits UV light (L) may be configured to rotate about its axis within a preset angular range by the micro motor 121b.

In this manner, by varying the irradiation direction of the UV irradiation unit 121 (\textcircled{1} [symbol] \textcircled{2} [symbol] \textcircled{3}), sterilization can be performed over a wider area without increasing the number of UV irradiation units 121.

Although exemplary embodiments of the present invention have been described, the idea of the present invention is not limited to the embodiments set forth herein. Those of ordinary skill in the art who understand the idea of the present invention may easily propose other embodiments through supplement, change, removal, addition, etc. of elements within the same idea, but the embodiments will be also within the idea scope of the present invention.

1. A beverage discharge device, comprising:
a faucet that comprises an inner flow path through which processed extracted water flows and an extraction port formed at the end of the inner flow path to allow the extracted water to be discharged to the outside;
a sterilization module having a UV irradiation unit on one side and rotatably coupled to the extraction port to be rotatable relative to the extraction port; and
a driving module configured to position the sterilization module at a first position where the UV irradiation unit faces the inner flow path or at a second position where the UV irradiation unit does not face the inner flow path but instead faces the extracted water being discharged through the extraction port.

2. The beverage discharge device of claim 1,
further comprising an input unit configured to receive a command for discharging the extracted water,
wherein the driving module positions the sterilization module at the second position in response to the command for discharging input from the input unit.

3. The beverage discharge device of claim 2, wherein the driving module positions the sterilization module at the first position upon completion of the extracted water discharge.

4. The beverage discharge device of claim 2, wherein the sterilization module continuously operates the UV irradiation unit while positioned at the second position.

5. The beverage discharge device of claim 3, wherein the sterilization module operates the UV irradiation unit only for a specific time interval while positioned at the first position.

6. The beverage discharge device of claim 5, wherein when returning from the second position to the first position, the sterilization module selectively operates the UV irradiation unit for a set time.

7. The beverage discharge device of claim 1,
wherein the sterilization module has a size and shape capable of blocking the extraction port of the faucet, which is oriented toward the ground, and
wherein one or more UV irradiation units are disposed on one side of the stopper.

8. The beverage discharge device of claim 7,
wherein the stopper comprises:
a hinge shaft formed on one side of an end of the faucet in which the extraction port is formed, and
a blocking plate that rotates about the hinge shaft as a central axis to block the extraction port.

9. The beverage discharge device of claim 8,
wherein the blocking plate further comprises:
a fixing member at an end opposite to the hinge shaft, the fixing member configured to be fixed to the other side of the end of the faucet.

10. The beverage discharge device of claim 8, wherein the blocking plate has a shape corresponding to the end of the faucet where the extraction port is formed.

11. The beverage discharge device of claim 8,
wherein the driving module comprises a motor, and
wherein the hinge shaft is operatively connected to a drive shaft of the motor.

12. The beverage discharge device of claim 1,
wherein the extraction port of the faucet has a polygonal shape in which one side is longer than the other sides, and
wherein the UV irradiation unit is disposed at the second position to face the extracted water discharged along the longer side.

13. The beverage discharge device of claim 12, wherein the extraction port has a rectangular shape.

14. The beverage discharge device of claim 1,
wherein the sterilization module comprises:
a first plate having a size and shape capable of blocking the extraction port and provided with the UV irradiation unit on one side, and
a second plate extending from one side of the first plate with a predetermined length,
wherein the first plate is configured to be slidable together with the second plate below the extraction port to block or open the extraction port and is configured to pivotally rotate relative to the second plate in the second position so that the UV irradiation unit is directed toward the extracted water.

15. The beverage discharge device of claim 14,
wherein the driving module comprises:
a motor, and a gearbox provided under the second plate.

16. The beverage discharge device of claim 14, wherein a plurality of UV irradiation units are arranged in a horizontal or vertical array.

17. The beverage discharge device of claim 1, wherein a plurality of UV irradiation units are arranged such that different numbers of UV irradiation units operate at the first position and the second position.

18. The beverage discharge device of claim 1, wherein the UV irradiation unit further comprises a micro motor provided on one side of the sterilization module and is configured to be rotatable about an axis within a preset angular range by the micro motor.
